(19) United States
(12) Patent Application Publication
(10) Pub. No.: US 2015/0014505 A1
(43) Pub. Date: Jan. 15, 2015

(54) Hardware Assembly

(71) Applicant: LIBERTY HARDWARE MFG.CORP., Winston-Salem, NC (US)

(72) Inventors: Neil Edwards, Kernersville, NC (US); Helli McDaniel, Whitsett, NC (US); Laura Hawkins, Madison, NC (US); Geraint Krumpe, Chicago, IL (US); William Spencer, Burlington, NC (US)

(73) Assignee: LIBERTY HARDWARE MFG.CORP., Winston-Salem, NC (US)

(21) Appl. No.: 13/937,715

(22) Filed: Jul. 9, 2013

(51) Int. Cl. F16M 13/02

(52) U.S. Cl. CPC F16M 13/02
USPC 248/251; 248/315; 248/311.2

(57) ABSTRACT

A hardware assembly is provided with a base for mounting to a support surface, the base having a longitudinal axis. A receiving member extends outwardly from the base along the longitudinal axis, the receiving member having an aperture. A hardware component is mounted to the receiving member in a plane that includes the longitudinal axis. According to at least one embodiment, an accessory may be removably received within the receiving member aperture.

### TECHNICAL FIELD

Embodiments relate to hardware assemblies, such as for use with interchangeable accessories.

### BACKGROUND

Hardware components, such as towel bars, tissue holders, towel rings, hooks, shelving, and the like are typically mounted to a support surface, such as a wall. The prior art has provided hardware assemblies with various post and base configurations.

### SUMMARY

According to at least one embodiment, a hardware assembly is provided with a base for mounting to a support surface, the base having a longitudinal axis. A receiving member extends outwardly from the base along the longitudinal axis, the receiving member having an aperture. A hardware component is mounted to the receiving member in a plane that includes the longitudinal axis.

According to at least another embodiment, a hardware assembly is provided having first and second bases for mounting to a support surface, the first and second bases having first and second longitudinal axes, respectively. First and second receiving members extend outwardly from the first and second bases along the first and second longitudinal axes, respectively, the first and second receiving members each having an aperture. A hardware component is mounted to the first and second receiving members in a plane that includes the first and second longitudinal axes.

According to at least another embodiment, a hardware assembly is provided with a base for mounting to a support surface, the base having a longitudinal axis. A receiving member extends outwardly from the base along the longitudinal axis, the receiving member having an aperture. A hardware component is mounted to the receiving member in a plane that includes the longitudinal axis, and an accessory is removably received within the receiving member aperture.

### BRIEF DESCRIPTION OF THE DRAWINGS

FIG. 1 is a perspective view of a hardware assembly including a towel bar according to an embodiment;

FIG. 2 is a top plan, fragmented view of the hardware assembly of FIG. 1;

FIG. 3 is a perspective view of a hardware assembly including a tissue holder according to another embodiment;

FIG. 4 is a perspective view of a hardware assembly including a tissue holder according to another embodiment;

FIG. 5 is a perspective view of a hardware assembly including a towel ring according to another embodiment;

FIG. 6 is a perspective view of the hardware assembly of FIG. 1 set to receive tray accessories;

FIG. 7 is a perspective view, partially cut away, of the hardware assembly of FIG. 1 with a tray accessory received therein;

FIG. 8 is a perspective view of a cup accessory according to an embodiment;

FIG. 9 is a perspective view of another cup accessory received within the hardware assembly of FIG. 5 according to an embodiment;

FIG. 10 is a perspective view of a toothbrush holder accessory according to an embodiment;

FIG. 11 is a side elevation view of a liquid dispenser accessory according to an embodiment;

FIG. 12 is a perspective view, partially cut away, of the hardware assembly of FIG. 1 with a vase accessory received therein;

FIG. 13 is a perspective view, partially cut away, of the hardware assembly of FIG. 1 with a hair dryer received therein;

FIG. 14 is a perspective view of a hardware assembly including a tissue holder according to an embodiment;

FIG. 15 is a top plan view of the hardware assembly of FIG. 14;

FIG. 16 is a perspective view of a hardware assembly including a towel ring according to another embodiment;

FIG. 17 is a perspective view of a hardware assembly including a towel bar with toothbrush holder and tray accessories received therein according to an embodiment; and

FIG. 18 is a perspective view of a tray accessory having a retention feature according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

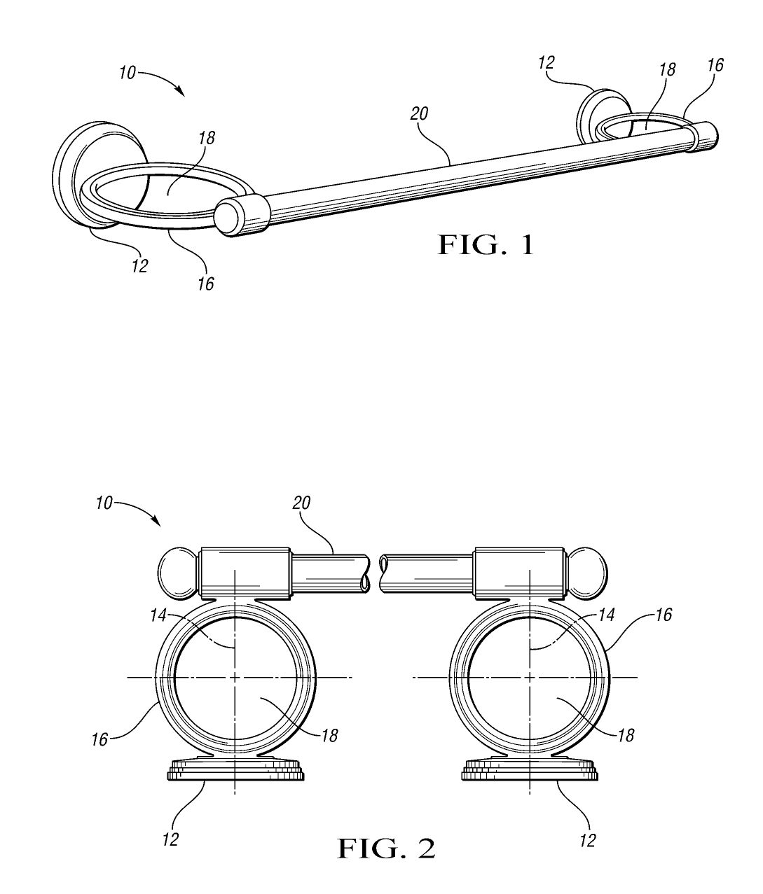

With reference first to FIGS. 1 and 2, a hardware assembly 10 is illustrated according to an embodiment. The hardware assembly 10 includes a base 12 for mounting to a support surface, such as a wall, wherein the base 12 has a longitudinal axis 14 (see FIG. 2). Instead of a standard post, a receiving member 16, such as a ring, extends outwardly from the base 12 along the longitudinal axis 14. The receiving member 16 has an aperture 18, such as for removably receiving an accessory therein to provide additional functionality to the hardware assembly 10, as described further below. A hardware component 20, such as a towel bar, is mounted to the receiving member 16 in a plane that includes the longitudinal axis 14. In the embodiment depicted in FIGS. 1 and 2, first and second bases 12 are provided in spaced relationship, each base 12 having a longitudinal axis 14, and the hardware component 20 is mounted to first and second receiving members 16 extending outwardly from the first and second bases 12 along the first and second longitudinal axes 14, respectively.

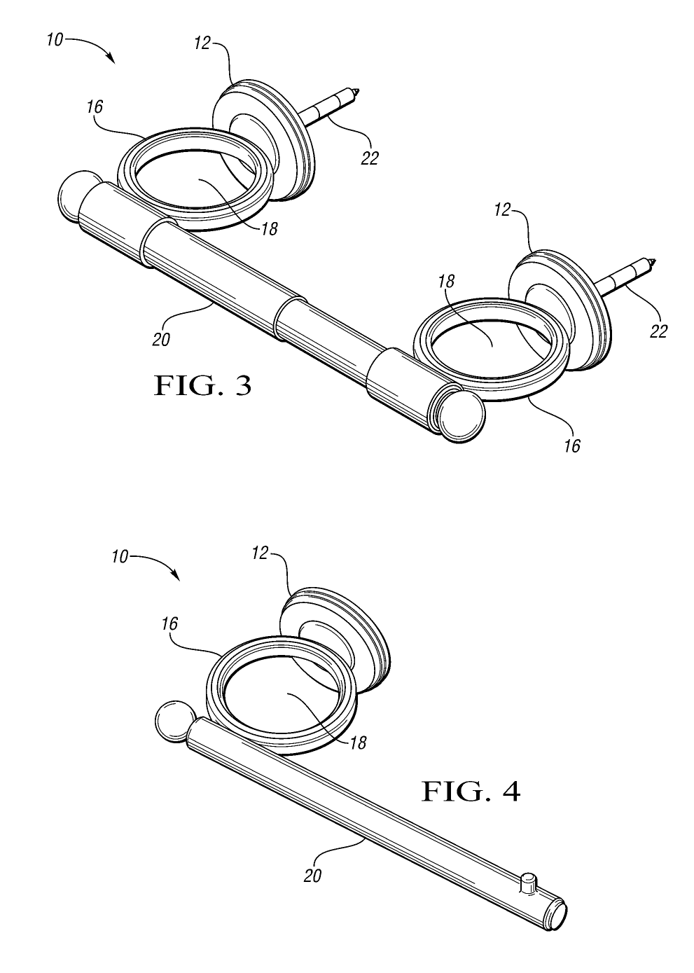

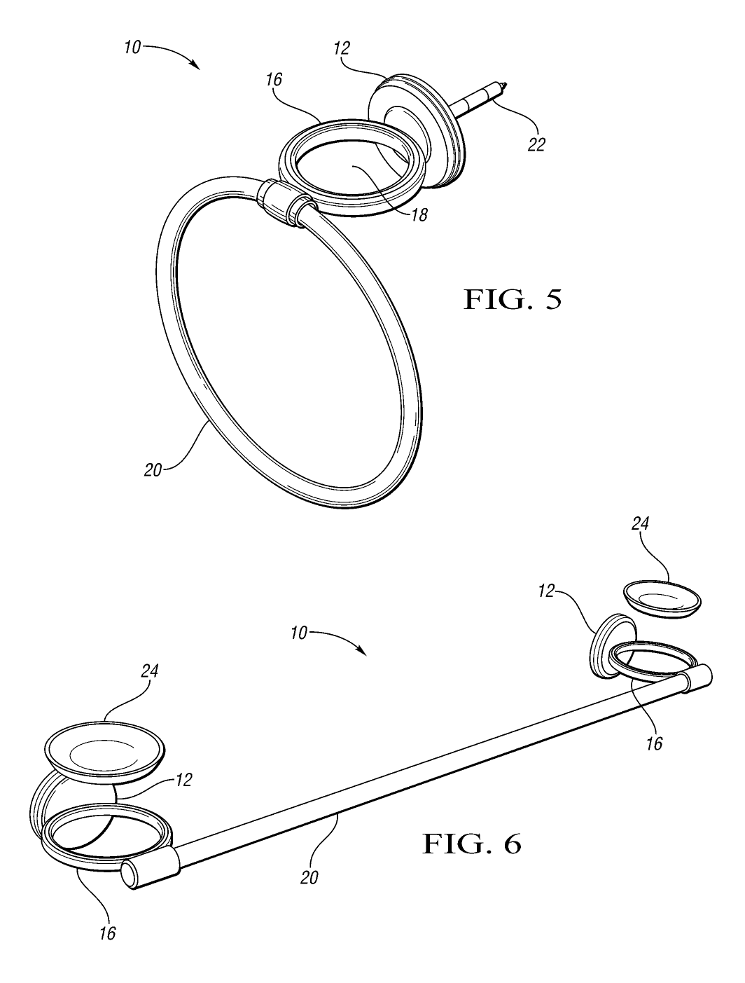

Although a hardware component 20 comprising a towel bar is illustrated in FIGS. 1 and 2, various domestic and commercial hardware components are contemplated, such as a tissue holder, towel ring, hook, shelf, and the like. For example, FIG. 3 illustrates an embodiment where the hardware component 20 comprises a tissue holder mounted between two receiving members 16, FIG. 4 illustrates an embodiment where the hardware component 20 comprises a tissue holder mounted to one receiving member 16, and FIG. 5 illustrates an embodiment where the hardware component 20 comprises a towel ring. With reference to FIGS. 3 and 5, the hardware assembly 10 may include a fastener assembly 22 such as, but not limited to, an expansion anchor, for fastening the base 12 to a support surface.

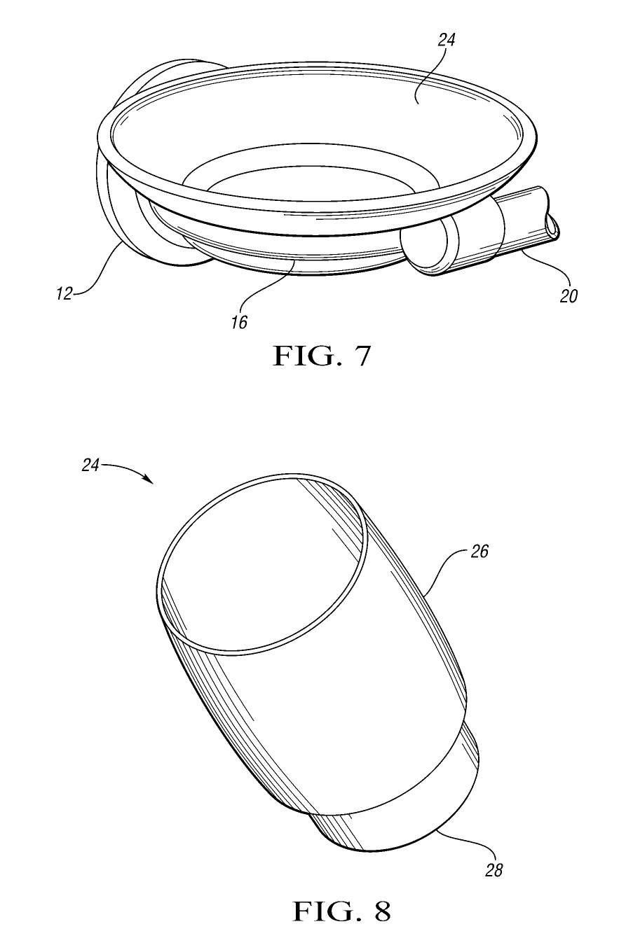

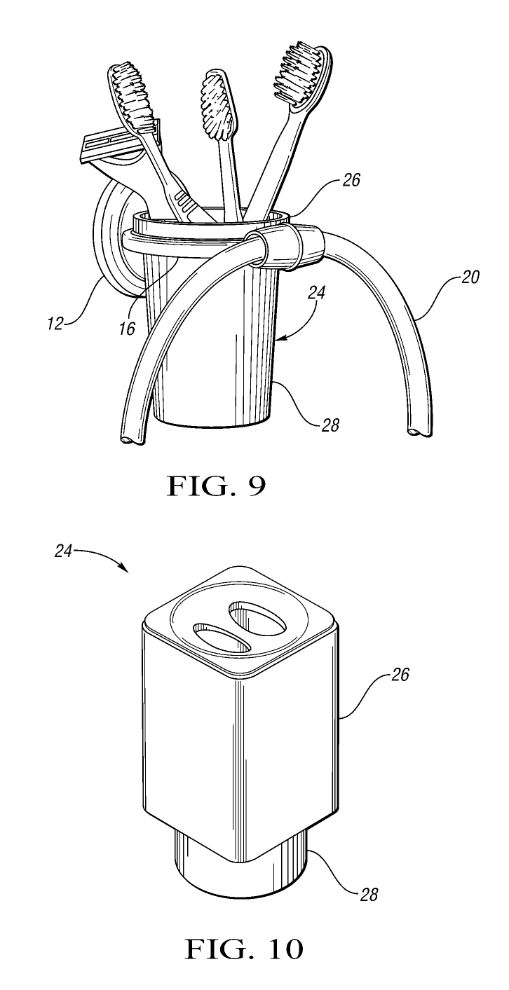

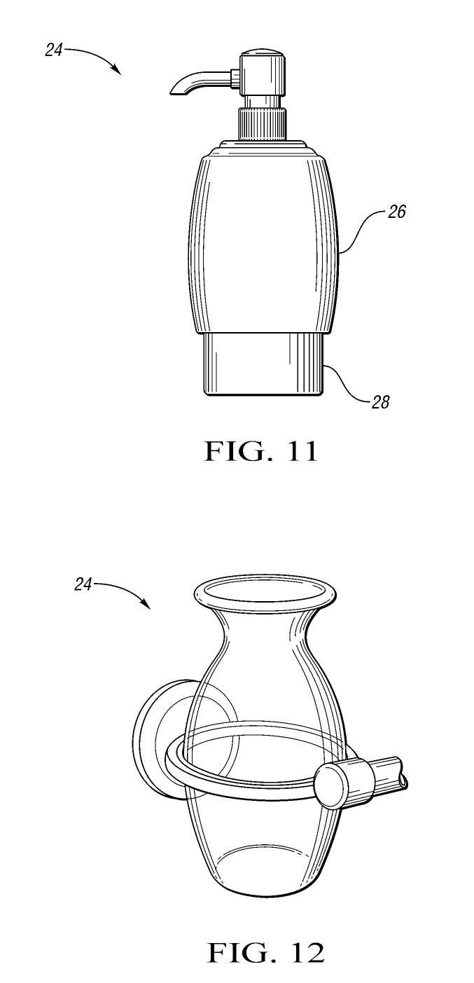

The receiving member 16 provides a storage solution built into the design of the hardware assembly 10 for temporary and permanent storage of everyday items. The receiving member 16 may removably receive a plurality of interchangeable accessories 24, allowing a user to increase the functionality of the hardware assembly 10 as well as to personalize their hardware and provide additional decorative options. For example, FIG. 6 shows the hardware assembly 10 of FIG. 1 set to receive tray or dish accessories, and FIG. 7 illustrates a tray accessory received within the receiving member 16. As further examples, FIG. 8 depicts a cup or tumbler accessory, FIG. 9 depicts another embodiment of a cup or tumbler accessory, FIG. 10 depicts a toothbrush holder accessory, FIG. 11 depicts a liquid dispenser accessory, such as a soap or lotion dispenser, and FIG. 12 depicts a vase accessory, although other accessories are also contemplated. For hardware assemblies 10 with more than one receiving member 16, each receiving member 16 may receive the same or different types of accessories 24 therein, allowing a user to customize the hardware assembly 10 based upon their decorative and functional needs.

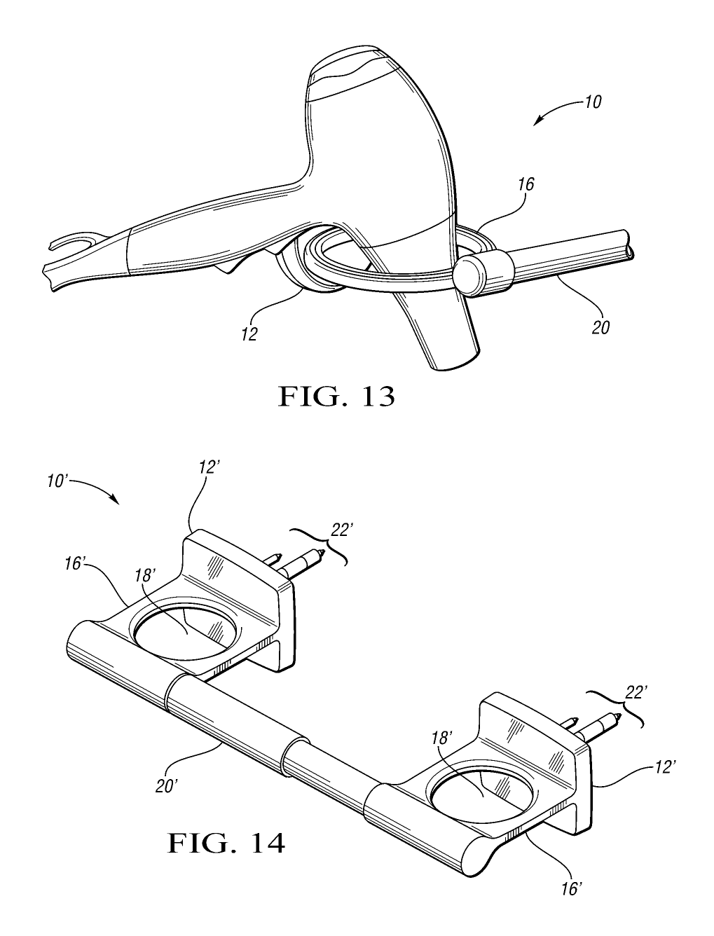

In addition to receiving accessories 24, the receiving member 16 may be used to store items such as curling irons or hair dryers, as depicted in FIG. 13, or as a location to hang hooks or hangers for additional storage. Although a generally circular aperture 18 is depicted, the aperture 18 may have any curvilinear or polygonal configuration. The hardware assembly 10 offers storage and aesthetic solutions for multiple rooms in the home such as, but not limited to, the bathroom, kitchen, and laundry room.

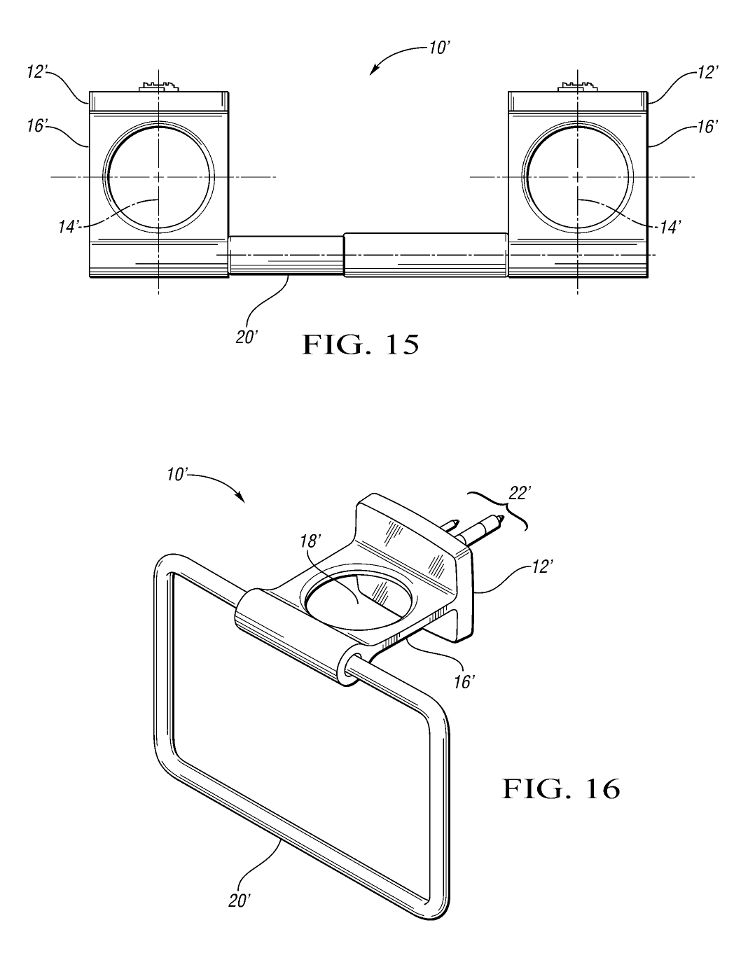

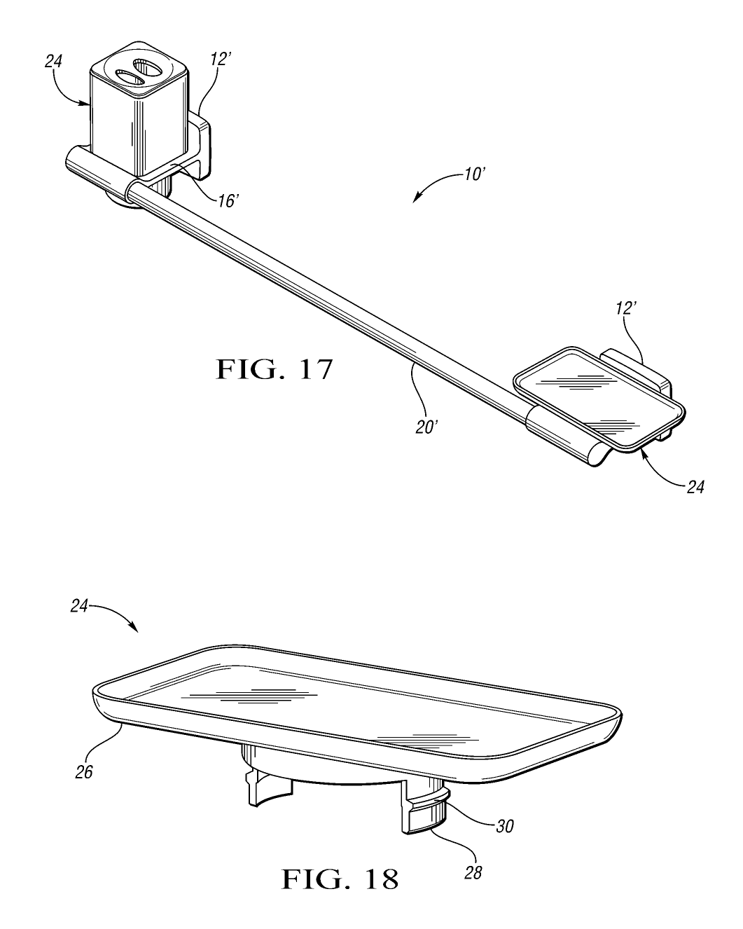

In another embodiment, the receiving member 16′ may have a platform configuration with an aperture 18′ therein as shown in FIGS. 14-17. Features described above for the embodiments of FIGS. 1-6 are also applicable to the embodiments of FIGS. 14-17, and like components are given like reference numerals with the addition of a prime (′) designation. A hardware component 20′ comprising a tissue holder is illustrated in FIGS. 14 and 15, and a hardware component 20′ comprising a towel ring is shown in FIG. 16. Of course, as described above, other hardware components are also contemplated. FIG. 17 illustrates a hardware assembly 10′ including a towel bar with toothbrush holder and tray accessories 24 received therein according to an embodiment.

As shown, for example, in FIGS. 8, 10 and 11, the accessory 24 may include an upper portion 26 and a lower portion 28, wherein the upper portion 26 has a greater diameter than the lower portion 28. The lower portion 28 may be received within the receiving member aperture 18 with the upper portion 26 resting on the receiving member 16, 16′. In an embodiment shown in FIG. 18, the lower portion 28 may be flexible and include at least one protrusion 30, so that when the accessory 24 is inserted into the receiving member 16, 16′, the lower portion 28 deflects allowing the protrusion 30 to pass through the receiving member aperture 18, 18′ and retain the accessory 24 within the receiving member 16, 16′, such as in a snap-fit manner. Although the protrusion 30 is illustrated herein on the lower portion 28 of a tray or dish-type accessory, other types of accessories may also include such a feature.

Since the receiving member 16, 16′ replaces a standard post in the hardware assembly 10, 10′, the receiving member 16, 16′ offers additional functionality while maintaining a compact footprint of the hardware assembly 10, 10′ within the desired living space, and minimizes the packaging required. In the embodiment of FIGS. 1-6, less than 25% of the receiving member 16 extends beyond the base 12 in a transverse direction, and in the embodiment of FIGS. 14-17, the receiving member 16′ does not extend beyond the base 12′ in a transverse direction. Furthermore, the integration of the receiving member 16, 16′ into the hardware assembly 10, 10′ in place of a post avoids obfuscating the overall design appearance of the hardware assembly 10, 10′.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A hardware assembly, comprising:
a base for mounting to a support surface, the base having a longitudinal axis;
a receiving member extending outwardly from the base along the longitudinal axis, the receiving member having an aperture; and
a hardware component mounted to the receiving member in a plane that includes the longitudinal axis.

2. The hardware assembly of claim 1, wherein less than 25% of the receiving member extends beyond the base in a transverse direction.

3. The hardware assembly of claim 1, wherein the receiving member comprises a ring.

4. The hardware assembly of claim 1, wherein the receiving member comprises a platform.

5. The hardware assembly of claim 1, wherein the aperture is curvilinear.

6. The hardware assembly of claim 1, wherein the hardware component comprises one of a towel bar, a tissue holder, or a towel ring.

7. A hardware assembly, comprising:
first and second bases for mounting to a support surface, the first and second bases having first and second longitudinal axes, respectively;
first and second receiving members extending outwardly from the first and second bases along the first and second longitudinal axes, respectively, the first and second receiving members each having an aperture; and
a hardware component mounted to the first and second receiving members in a plane that includes the first and second longitudinal axes.

8. The hardware assembly of claim 7, wherein the receiving member comprises a ring.

9. The hardware assembly of claim 7, wherein the receiving member comprises a platform.

10. The hardware assembly of claim 7, wherein the aperture is curvilinear.

11. The hardware assembly of claim 7, wherein the hardware component comprises one of a towel bar, a tissue holder, or a towel ring.

12. A hardware assembly, comprising:
a base for mounting to a support surface, the base having a longitudinal axis;
a receiving member extending outwardly from the base along the longitudinal axis, the receiving member having an aperture;
a hardware component mounted to the receiving member in a plane that includes the longitudinal axis; and
an accessory removably received within the receiving member aperture.

13. The hardware assembly of claim 12, wherein less than 25% of the receiving member extends beyond the base in a transverse direction.

14. The hardware assembly of claim 12, wherein the receiving member comprises a ring.

15. The hardware assembly of claim 12, wherein the receiving member comprises a platform.

16. The hardware assembly of claim 12, wherein the aperture is curvilinear.

17. The hardware assembly of claim 12, wherein the accessory has an upper portion and a lower portion, the upper portion having a greater diameter than the lower portion, wherein the lower portion is received within the receiving member aperture.

18. The hardware assembly of claim 17, wherein the accessory lower portion includes at least one protrusion, the accessory lower portion being flexible so as to deflect and allow the protrusion to pass through the receiving member aperture and retain the accessory within the receiving member.

19. The hardware assembly of claim 12, wherein the hardware component comprises one of a towel bar, a tissue holder, or a towel ring.

20. The hardware assembly of claim 12, wherein the accessory comprises one of a cup, a vase, a toothbrush holder, a liquid dispenser, or a tray.
